(19) United States
(12) Patent Application Publication
(10) Pub. No.: US 2025/0154815 A1
(43) Pub. Date: May 15, 2025

(54) Crane Cabin Door System

(71) Applicant: MANITOWOC CRANE GROUP FRANCE SAS, DARDILLY (FR)

(72) Inventor: Dirk EWE, WESTERSTEDE (DE)

(21) Appl. No.: 18/945,897

(22) Filed: Nov. 13, 2024

(30) Foreign Application Priority Data
Nov. 14, 2023 (DE) 102023131660.5

(51) Int. Cl. E05F 15/63; E05F 15/77

(52) U.S. Cl. CPC E05F 15/63; E05F 15/77; E05Y 2400/652; E05Y 2900/518; E05Y 2900/531

(57) ABSTRACT

A crane cabin door system for a mobile crane includes a door which is designed to close an access opening of the crane cabin and guided between an open position and a closed position by a guide mechanism; a door drive which is designed to move the door between the open position and the closed position; and a control unit which is connected to the door drive and to at least one control element and which actuates the door drive in accordance with a user input made via the at least one control element.

### FIELD

The present disclosure relates to a door system for a crane cabin of a mobile crane. The present disclosure also relates to a mobile crane in which the crane cabin comprises such a door system.

### BACKGROUND

During crane operations, mobile cranes are usually operated by the crane operator from the crane cabin. While larger mobile cranes are provided with a crane cabin provided specifically for operating during crane operations in addition to the driver's cab provided on the crane undercarriage for driving operations, smaller mobile cranes such as for example so-called off-road cranes may only be provided with one working space from which the crane is operated during both driving operations and crane operations.

In more recent crane designs, it is common for the crane cabin to be equipped with a sliding door which can be opened or slid open as widely as desired by the crane operator, wherein it is far less of a hindrance than a hinged swing door such as is often to be found in older crane designs.

In particular when the crane cabin is arranged on the superstructure, the cabin door has to be grasped and operated by the crane operator from different positions, depending on the rotational angular position of the crane superstructure, in order to open or close it from outside the cabin. In addition, the door handle provided for this purpose is situated in different positions depending on the open position of the door and thus not always convenient or ergonomic for the crane operator to grasp.

### SUMMARY

It is the object of the present disclosure to remedy this disadvantage and to provide a door system which enables the crane cabin door to be operated in a consistently convenient and ergonomically optimised way.

For this purpose, the crane cabin door system in accordance with the present disclosure comprises:
a door which is designed to close an access opening of a crane cabin and guided between an open position and a closed position by a guide mechanism;
a door drive which is designed to move the door between the open position and the closed position; and
a control unit which is connected to the door drive and to at least one control element and which actuates the door drive in accordance with a user input made via the at least one control element.

The door system thus comprises an automatically moving cabin door which, unlike previous cabin doors, no longer has to be opened or closed manually by the crane operator. Instead, a simple user input made via a control element is sufficient in order to open or close the door. Since operating forces thus no longer have to be applied, in particular from different positions of the crane operator relative to the cabin door, not only the operating convenience and ergonomics but in some cases also the level of safety when operating the crane cabin door is increased.

In accordance with one embodiment, the guide mechanism and/or the door drive is designed to fix in position, and in particular to secure, the door in at least one intermediate position, in particular a predefined or arbitrary intermediate position, between the open position and the closed position.

In other words, the door drive can be actuated such that the cabin door can remain not only in its end positions, i.e. in a closed position and an open position, but instead in one or any number of intermediate positions. This is advantageous in particular when the surroundings of the crane are to be better perceived acoustically or the crane cabin is to be additionally ventilated. Within this context, at least one predefined locking position for the cabin door is conceivable, in which the partially opened cabin door effectively prevents people from falling out of the cabin and equally prevents objects from entering the cabin. It is also conceivable for the door to be held not only by the guide mechanism and/or the door drive, for example by internal friction forces, but to instead be actively secured in its present position, for example by a locking or braking mechanism. The door drive can comprise one or more electric motors which provide the drive output required in order to move the door. Within this context, it is in particular conceivable for the door drive to comprise one or more 12-volt or 24-volt DC motors which act on one or more swing arms coupled to the cabin door and in particular cause them to rotate.

Although the present design can in principle be used for any type of cabin door, for example swing doors which are rotationally mounted on the crane cabin or sliding doors which are substantially guided translationally, the guide mechanism can be embodied as an outward pivoting door mechanism in accordance with one embodiment. The door thus moves between the open position and the closed position in the manner of an outward pivoting door, wherein the door is moved predominantly parallel to the extent of the access opening and the associated cabin wall in order to open or close the access opening, whereas it moves predominantly perpendicular to this near to its closed position in order to extend from or retract into its fitting in the crane cabin wall. This enables the cabin door to be better sealed off from the crane cabin, in particular as compared to conventional sliding doors, which provides advantages in particular in relation to exposure to pollutants and noise, drafts and the ingress of dust. For this purpose, the guide mechanism can for example be embodied as a coupling linkage or four-bar linkage.

In accordance with another embodiment, the control unit can be connected for the purpose of signal transmission to the door drive and/or to at least one control element via a CAN bus. It is equally possible for the control unit to be integrated into the crane controller of the mobile crane and in particular to represent a function of the crane controller of the mobile crane.

In other words, the operation of the door system in accordance with the disclosure can be interpreted not only as an independent system, but can instead also be integrated or incorporated into the existing signal transmitting infrastructure of the mobile crane.

In accordance with another embodiment, the control unit actuates the door drive in accordance with at least one crane status variable and/or at least one environmental parameter and in particular in accordance with at least one sensor value, wherein it is in particular possible to prioritise this over a user input made via a control element. It is equally possible to subordinate this quasi-automatic actuation of the door drive to user inputs. The cabin door could for example close automatically if an increased exposure to dust is detected via one or more sensors. If the crane operator nonetheless wants the cabin door at least partially opened, in order for example to be able to better perceive the surroundings acoustically, then the crane operator could open the cabin door again via a user input. In other cases, for example if an increased exposure to pollutants is measured by one or more sensors, the cabin door could be closed regardless of a user input, until the concentration of pollutants has reached an acceptable level again. Equally, one or more different crane status variables could influence the operation of the cabin door. If the crane cabin can be tilted in accordance with the luffing angle of the boom, it is conceivable for it to only be possible to fully open the cabin door once the crane cabin has returned to its horizontal orientation. Similarly, it could also only be possible to fully open the cabin door once an ascending or access aid, such as a running board, has reached its position necessary for entering or exiting the cabin.

Instead of preventing the cabin door from opening, the control unit could cause an acoustic and/or optical warning signal, emitted by a signal lamp or a loudspeaker, in accordance with at least one status variable and/or at least one environmental parameter. Equally, such an acoustic and/or optical warning signal can be emitted before or as the door drive moves the cabin door between the open position and the closed position.

In accordance with another embodiment, one or more control elements can be arranged on the mobile crane, in particular:
in the driver's cab of the mobile crane;
in and/or on the outside of the crane cabin of the mobile crane;
on the undercarriage of the mobile crane, in particular in the region for ascending to the crane cabin; and/or
on the superstructure of the mobile crane, in particular in the region for ascending to the crane cabin.

In addition to or as an alternative to one or more of the aforementioned control elements, a control element can also be integrated in a portable, in particular wireless remote control for the mobile crane or provided in such a design.

Another aspect of the present disclosure relates to a mobile crane comprising a crane cabin door system in accordance with any one of the embodiments described above. The door system can in particular be provided for a crane cabin arranged on the crane superstructure, while being equally suitable for a crane cabin arranged on the crane undercarriage.

### BRIEF DESCRIPTION OF THE DRAWINGS

A preferred embodiment of the present disclosure is explained in more detail below by referring to the enclosed figures. The present disclosure can comprise all of the features disclosed here, individually and in any expedient combination. There is shown:

FIG. 1 an embodiment of the door system in accordance with the disclosure, with the cabin door situated in its closed position;

FIG. 2 the door system of FIG. 1, with the cabin door situated in a first intermediate position;

FIG. 3 the door system of FIG. 1, with the cabin door situated in a second intermediate position; and

FIG. 4 the door system of FIG. 1, with the cabin door in its open position.

### DESCRIPTION

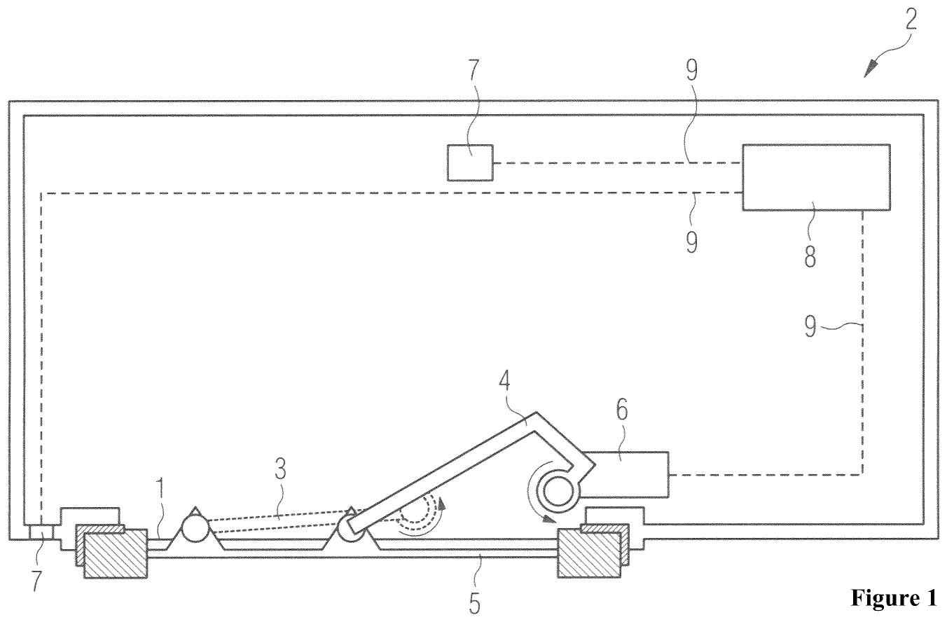

FIG. 1 schematically shows a plan view onto a crane cabin 2 comprising a preferred embodiment of the door system in accordance with the present disclosure. The front side, i.e. the side of the crane cabin pointing towards the crane boom, is situated on the left-hand side in the representation shown. An access opening 1, via which the crane operator can enter and also then exit the crane cabin 2 is provided in the left-hand side wall of the crane cabin 2, i.e. the side wall arranged at the bottom in the representation. A cabin door 5, which is connected to the crane cabin 2 via a guide mechanism which in the embodiment shown is designed as a coupling linkage or four-bar linkage, is provided for closing the access opening 1. As can be seen by viewing FIGS. 1 to 4 collectively, the door 5 is connected to the crane cabin 2 via two swing arms 3, 4. The two swing arms 3, 4 are connected to each of the door 5 and the crane cabin 2 via rotary bearings at their opposite ends, wherein the rotary axes of all of the rotary bearings extend in parallel. The first swing arm 3 extends below the access opening 1, while the second swing arm 4 is situated in the upper region of the access opening 1 and can be rotated about its vertical rotary axis via an electric motor 6. The electric motor 6 can in particular be a 12-volt DC motor or a 24-volt DC motor and can accordingly be directly supplied with power via the crane's on-board power supply. The first swing arm 3 is not driven and accordingly follows the movement of the second swing arm 4 and the door 5. In conventional nomenclature, the crane cabin 2 thus represents the frame of the coupling linkage, while the door 5 forms the so-called joint.

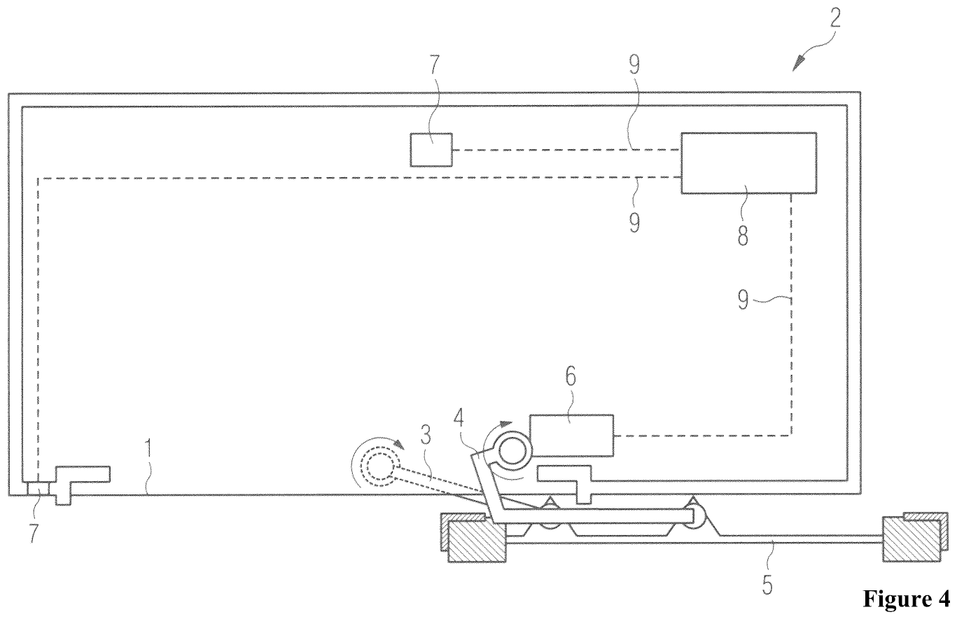

In order to move the door 5 between the closed position shown in FIG. 1 and the open position shown in FIG. 4, the door drive 6 which acts on the second swing arm 4 is actuated by the control unit 8 via a signal line of the CAN bus 9. The control unit 8 likewise receives the corresponding user inputs via signal lines of the CAN bus 9, via which the control unit 8 is connected for the purpose of signal transmission to control elements 7, wherein the control elements 7 can be designed as push buttons. If, as shown in FIG. 1, the control elements 7 are arranged both on the outer wall of the crane cabin 2 and in the interior of the crane cabin 2, it is possible for a crane operator to open the door 5 and also close it again without having to grasp it. The door 5 and thus also a handle fastened to it assume different positions relative to the crane cabin 2 depending on the open position of the door 5, while the control elements 7 or push buttons remain at a known location.

If the door 5 is to be moved from its closed position shown in FIG. 1 to a fully or partially opened position, the electric motor 6 is activated via the control unit 8 by operating one of the control elements 7, such that the electric motor 6 rotates the second swing arm 4 about its rotary bearing and in the direction of the arrow shown in FIG. 1. The first swing arm 3 follows the movement of the second swing arm 4, to which it is coupled via the door 5, likewise about its rotary bearing and in the direction of the arrow shown in FIG. 1.

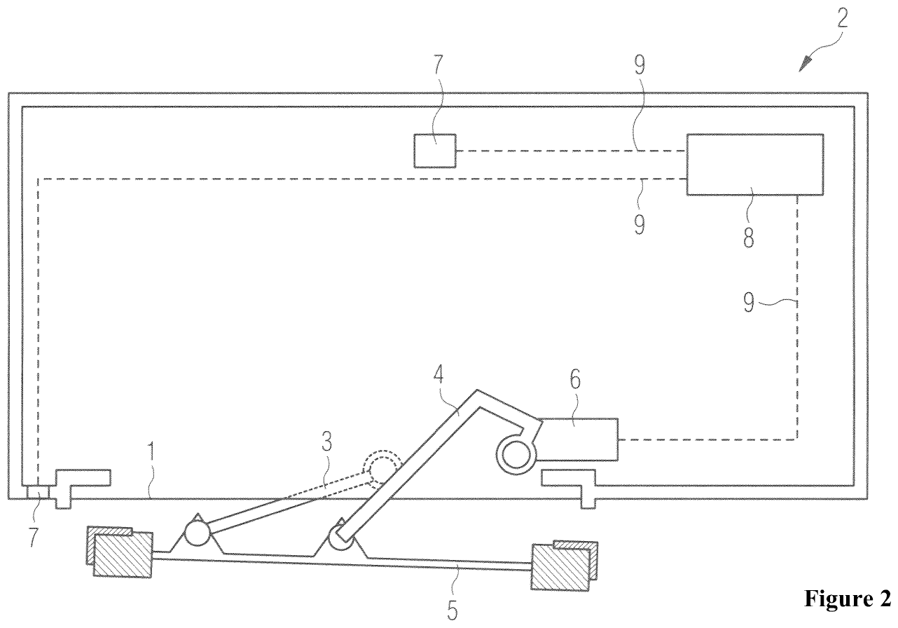

FIG. 2 shows how the door 5 initially moves predominantly perpendicular to the extent of the door opening 1, i.e. moves out of its fitting in the cabin wall, so to speak. The position of the door 5 shown in FIG. 2 can be referred to as a first intermediate position at which the crane operator is better able to acoustically perceive the surroundings of the mobile crane from within the crane cabin.

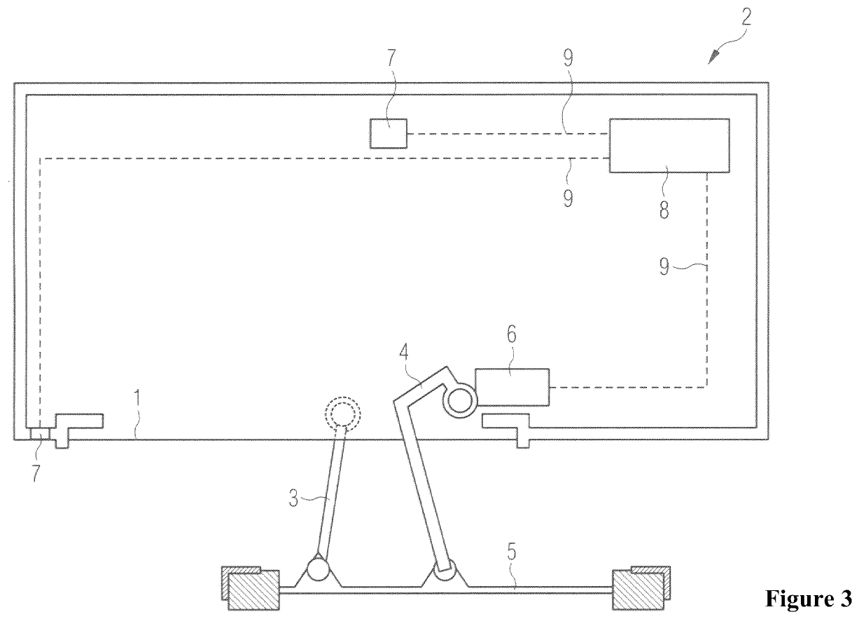

In FIG. 3, the door 5 has assumed a second intermediate position in which it is opened further than in the intermediate position shown in FIG. 2, ensuring for example that the crane cabin 2 is sufficiently ventilated.

If the door drive 6 continues to be operated, the door 5 ultimately reaches its open position shown in FIG. 4, in which the access opening 1 is opened widely enough for the crane cabin 2 to be entered or exited. In order for the door 5 which is situated in the open position to be closed again, one of the control elements 7 is again operated, causing the door drive 6 to rotate the second swing arm 4 about its rotary bearing in the direction of the arrow shown in FIG. 4. The first swing arm 3 correspondingly follows this movement and rotates about its rotary bearing in the same direction.

As an alternative to or in addition to the discrete positions of the cabin door 5 shown in FIGS. 1 to 4, it is also possible to position the cabin door 5 “non-incrementally”, so to speak, in any position or in particular to secure it in any position using a braking mechanism (not shown). For this purpose, the door drive 6 can for example rotate the second swing arm 4 for as long as a control element 7 designed as a push button is pressed. When the push button is released, the door 5 remains in its present position or is secured in said position against any unintentional movement. When a control element 7 is pressed again, the movement of the door 5 can be resumed.

1-10. (canceled)

11. A crane cabin door system for a mobile crane, comprising:
a door which is designed to close an access opening of a crane cabin, wherein the door is guided between an open position and a closed position by a guide mechanism;
a door drive which is designed to move the door between the open position and the closed position; and
a control unit which is connected to the door drive and to at least one control element and which actuates the door drive in accordance with a user input made via the at least one control element.

12. The crane cabin door system according to claim 11, wherein the guide mechanism and/or the door drive is designed to fix in position the door in at least one intermediate position between the open position and the closed position.

13. The crane cabin door system according to claim 12, wherein the guide mechanism and/or the door drive is designed to secure the door in at least one intermediate position.

14. The crane cabin door system according to claim 12, wherein the at least one intermediate position is predefined.

15. The crane cabin door system according to claim 12, wherein the at least one intermediate position is arbitrary.

16. The crane cabin door system according to claim 11, wherein the guide mechanism is embodied as an outward pivoting door mechanism.

17. The crane cabin door system according to claim 11, wherein the control unit is connected for the purpose of signal transmission to the door drive and/or to at least one control element via a CAN bus.

18. The crane cabin door system according to claim 11, wherein the control unit is integrated into the crane controller of the mobile crane.

19. The crane cabin door system according to claim 18, wherein the control unit represents a function of the crane controller mobile crane.

20. The crane cabin door system according to claim 11, wherein the control unit actuates the door drive in accordance with at least one crane status variable and/or at least one environmental parameter.

21. The crane cabin door system according to claim 11 wherein the control unit actuates the door drive in accordance with at least one sensor value.

22. The crane cabin door system according to claim 11, wherein the control unit causes an acoustic and/or optical warning signal to be emitted in accordance with at least one crane status variable and/or at least one environmental parameter before and/or as the door drive is moving.

23. The crane cabin door system according to claim 11, wherein the at least one control element is arranged in at least one of the following: in a driver's cab of the mobile crane; in and/or on the outside of a crane cabin of the mobile crane; on an undercarriage of the mobile crane; in the region for ascending to the crane cabin; and/or on a superstructure of the mobile crane, in particular in the region for ascending to the crane cabin.

24. The crane cabin door system according to claim 11, wherein a control element is integrated in a portable, in particular wireless remote control for the mobile crane or provided in such a design.

25. A mobile crane comprising a crane cabin door system according to claim 11.
